(19) United States
(12) Patent Application Publication
(10) Pub. No.: US 2026/0365533 A1
(43) Pub. Date: Nov. 19, 2026

(54) VATERITE SYNTHESIS VIA PORTLANDITE CARBONATION

(71) Applicant: The Regents of the University of California, Oakland, CA (US)

(72) Inventors: Gaurav Sant, Los Angeles, CA (US); Dale Prentice, Los Angeles, CA (US); Dante Simonetti, Los Angeles, CA (US); Jenny Arabit, Los Angeles, CA (US)

(21) Appl. No.: 19/133,107

(22) PCT Filed: Nov. 28, 2023
(86) PCT No.: PCT/US2023/081296

§ 371 Date: May 27, 2025

Related U.S. Application Data
(60) Provisional application No. 63/428,272, filed on Nov. 28, 2022.

(51) Int. Cl. C01F 11/18

(52) U.S. Cl. CPC C01F 11/181; C01F 11/182; C01F 11/185

(57) ABSTRACT

The present disclosure relates to methods of producing stabilized vaterite by carbonating portlandite or other alkaline calcium bearing feedstocks. In particular, the present methods comprise: (i) combining Ca(OH)₂ with an additive to form a reactant mixture; (ii) carbonating the reactant mixture with a CO₂ source to form a CaCO₃ product; and (iii) adding a stabilizing agent to Step (ii). The stabilized vaterite produced in accordance with the present methods may be useful in production of calcium carbonate cements.

### CROSS-REFERENCE TO RELATED APPLICATION

This application claims the benefit of priority to U.S. Provisional Patent Application No. 63/428,272, filed Nov. 28, 2022, which is incorporated herein by reference in its entirety for all purposes.

### STATEMENT REGARDING FEDERALLY SPONSORED RESEARCH

This invention was made with government support under Grant Number DE-FE0031718, awarded by U.S. Department of Energy and under Grant Number 1922167, awarded by the National Science Foundation. The government has certain rights in the invention.

### BACKGROUND

Ca(OH)₂ (Portlandite) carbonated under humid conditions can readily react with CO₂ to produce CaCO₃ at near ambient conditions. The partial substitution of cement with vaterite, a CaCO₃ polymorph, may enhance the early strength gain of concrete (“calcium carbonate cement”). emissions have been identified as a major contributor to global warming and ocean acidification. Utilization of calcium carbonate cement to partially or fully replace ordinary Portland cement (OPC) can potentially reduce the embodied carbon intensity (eCI) of concrete through CO₂ capture during vaterite production. However, current methods for producing vaterite at near ambient conditions are limited. Current methods use an alkaline, calcium-rich, solution that may favorably form vaterite upon the introduction of a carbonate source. Liquid phase methods typically use readily soluble reactants, such as CaCl₂ and Ca(NO₃)₂ salts, and additives to promote vaterite formation and increase solution pH to enhance CO₂ absorption into solution. Some methods include solubilizing units to dissolve cheaper but solubility limited Ca-feedstock like Ca(OH)₂ and CaSO₄. Other methods use multi-purpose additives like NH₄OH to simultaneously promote CO₂ absorption and vaterite formation. With the addition of auxiliary chemicals, scrubbing units may be required to remove chemical species such as KCl and ammonium-bearing species, which may accelerate the degradation of the final concrete product, and for capturing any produced toxic gases that were generated during the reaction.

Accordingly, there is a need for improved methods of producing vaterite at a scale appropriate for use in cement and concrete production.

### SUMMARY OF THE INVENTION

The present disclosure provides methods of preparing stabilized vaterite by carbonating portlandite. In some aspects, the method of producing stabilized vaterite comprises:
(i) combining an alkaline calcium source with an additive to form a reactant mixture;
(ii) carbonating the reactant mixture with a CO₂ source to form a solid CaCO₃ product comprising vaterite; and
(iii) adding a stabilizing agent to the solid CaCO₃ product of step (ii) thereby producing the stabilized vaterite.

### BRIEF DESCRIPTION OF THE DRAWINGS

FIG. 1 is a block flow diagram of vaterite formation according to certain embodiments of the invention.

FIG. 2 details an exemplary apparatus for bench-scale production of the vaterite synthesis method. The apparatus (100) comprises of two mass flow controllers that feed high purity CO₂ (110) and compressed air (120) into two gas washing bottles (130) in Oven A (140) to achieve a specified CO₂ and water vapor concentration. In oven A (104), the air CO₂ dry gas mixture picks up moisture as it flows through the gas washing bottles series and travels through a coiled copper tubing in Oven B (150) before reaching the stainless-steel reactor manifold (160). At the manifold inlet (170), an inline relative humidity and temperature probe (180) monitors the reactor relative humidity and temperature.

### DETAILED DESCRIPTION OF THE INVENTION

The present disclosure provides methods for the preparation of vaterite from portlandite using carbon dioxide, and in particular, carbon dioxide from a flue gas source.

### Definitions

Unless otherwise defined herein, scientific and technical terms used in this application shall have the meanings that are commonly understood by those of ordinary skill in the art.

Chemistry terms used herein, unless otherwise defined herein, are used according to conventional usage in the art, as exemplified by “The McGraw-Hill Dictionary of Chemical Terms”, Parker S., Ed., McGraw-Hill, San Francisco, C.A. (1985).

All of the above, and any other publications, patents and published patent applications referred to in this application are specifically incorporated by reference herein. In case of conflict, the present specification, including its specific definitions, will control.

As used herein, the terms “optional” or “optionally” mean that the subsequently described event or circumstance may occur or may not occur, and that the description includes instances where the event or circumstance occurs as well as instances in which it does not.

“Carbonation” as used herein refers to any reaction of a compound or material with CO₂ to form carbon-containing products including, as a non-limiting example, the carbonation of Ca(OH)₂ with CO₂ to form calcium carbonate, CaCO_{3.}

As used herein, the term “CO₂-containing flue gas” refers to an effluent gas stream from a source other than the atmosphere that contains carbon dioxide (CO₂).

Certain ranges are presented herein with numerical values being preceded by the term “about.” As used herein, the terms “substantially” and “about” are used to describe and account for small variations. When used in conjunction with an event or circumstance, the terms can refer to instances in which the event or circumstance occurs precisely as well as instances in which the event or circumstance occurs to a close approximation. For example, when used in conjunction with a numerical value, the terms can encompass a range of variation of less than or equal to ±10% of that numerical value, such as less than or equal to ±5%, less than or equal to ±4%, less than or equal to ±3%, less than or equal to ±2%, less than or equal to ±1%, less than or equal to ±0.5%, less than or equal to +0.1%, or less than or equal to ±0.05%.

### Methods for Producing Vaterite

Portlandite (Ca(OH)₂) carbonated under humid conditions readily reacts with CO₂ to produce CaCO₃, a chemical component that contributes to the early strength gain of concrete, at near ambient conditions. Under these operating conditions, the polymorphic transition of the nascent carbonate product is postulated to be driven by dehydration, wherein the precursor hydrated polymorphs transform into one or both of its metastable anhydrous forms, aragonite and vaterite, before turning into the most stable form, calcite. Aragonite has an orthorhombic crystal system typically forming acicular crystals. Repeated twinning results in pseudo-hexagonal forms. Aragonite may be columnar or fibrous. Vaterite is a polymorph of CaCO₃ also known as mu-calcium carbonate (μ-CaCO₃), which has a hexagonal substructure. Vaterite is the least thermodynamically stable anhydrous calcium carbonate polymorph and can easily transform into more stable calcite or aragonite in the presence of water or heat.

While not being bound by theory, arresting the polymorphic transition of CaCO₃ at the vaterite form and preventing its transition to aragonite may enhance the early strength gain of concrete (e.g., calcium carbonate cement) when used as a partial cement replacement. The improved early strength gain is thought to stem from the greater solubility and porous structure of vaterite. As a partial cement replacement, vaterite may act as a nucleation site to expedite ettringite and carboaluminate, which are hydrated phases that are formed during cement hydration, formation. As a full cement replacement, the controlled transformation of vaterite into high aspect ratio aragonite may produce a porous honeycombed structure of dense intertwining aragonite needles that precipitate from the spherulite vaterite. Embodied carbon intensity (eCI) refers to the greenhouse gas emissions, particularly carbon dioxide, resulting from the mining, harvesting, processing, manufacturing, transportation and installation of building materials. Utilization of a calcium carbonate cement to partially replace ordinary Portland cement (OPC) can potentially reduce the eCI of concrete through CO₂ capture during vaterite production according to embodiments of the invention. Current methods for vaterite synthesis at near ambient conditions are limited to gas-liquid or liquid-liquid reaction pathways that utilize an alkaline, calcium-rich solution to favorably form vaterite upon introducing a carbonate source. However, these methods often require high reactant concentrations. Consequently, readily soluble reactants (e.g., CaCl₂ and Ca(NO₃)₂), an alkaline source to promote CO₂ absorption and additives to promote vaterite formation may be added into the reacting solution. To reduce the process complexity, other methods have included a preceding solubilizing reactor to dissolve cheaper but solubility limited Ca-feedstocks (e.g., Ca(OH)₂ and CaSO₄) and multi-purpose basic compounds, such as NH₄OH, that may dually promote vaterite formation and increase the solution pH. Thus, additional operating units may also be used for scrubbing chemical species such as KCl and ammonium bearing species that may accelerate concrete degradation, and any produced toxic gases.

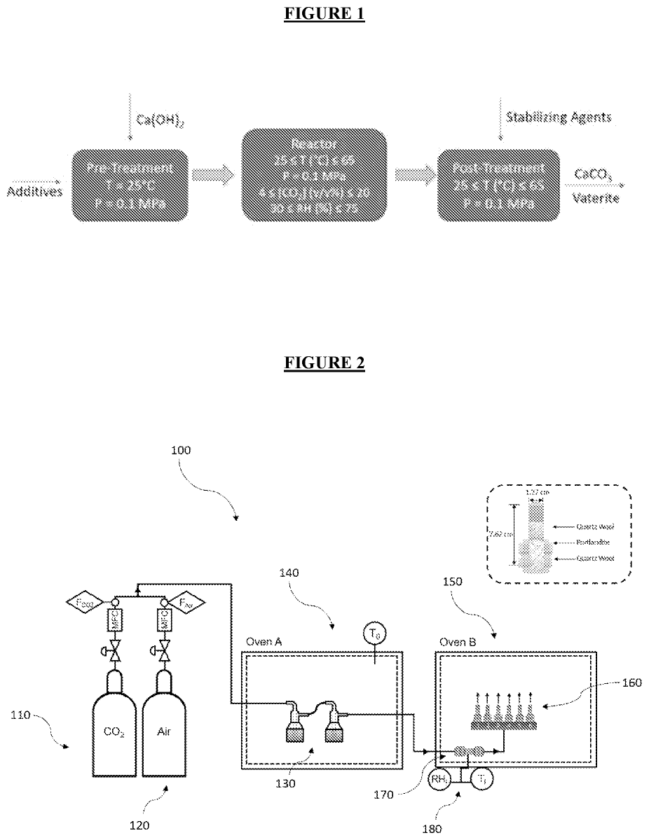

Accordingly, vaterite synthesis according to embodiments of the present disclosure advantageously simplifies the process by using a coupled dissolution-precipitation reaction pathway to induce the carbonation of Ca(OH)₂ or an alkaline calcium source at near ambient conditions. While not being bound by theory, the present vaterite synthesis methods are macroscopically gas-solid, providing a potential reduction in reactor size, while microscopically gas-solid-liquid, thereby promoting a dissolution-precipitation reaction. The hydrated interface of Ca(OH)₂ provides a highly alkaline (pH~12.46 at 25 °C) and calcium rich medium that can be physically and chemically altered to promote vaterite formation using CO₂ and additives. The block flow diagram of a method according to some embodiments (FIG. 1) demonstrates the following processing steps:

### 1. Pre-Treatment of Portlandite:

Portlandite (Ca(OH)₂) is combined with additives that favor vaterite formation (non-limiting examples include Mg(OH)₂, MgO, CaSO₄, and NaOH) at room temperature, and, if necessary, mechanically treated to produce a primed solid reactant mixture. [see, e.g., 10,16,17] In some embodiments, the molar ratio of [Ca]:[Mg] is in a range of about 0.1-0.25.

### 2. Carbonation:

The primed solid reactants produced in step 1 are carbonated in a carbonation reaction under conditions that promote vaterite formation over aragonite or calcite. Conditions include a temperature of about 25≤T (°C)≤65, a CO₂ concentration of about 4≤[CO2] (volume %)≤20, and a relative humidity of about 30≤Relative Humidity “RH” (%)≤75. [7,18-20]

### 3. Post-Treatment:

The vaterite is stabilized with a compound that inhibits calcite formation. The concentration of the added stabilizing agent is in the range of about 1 to 90 mass % of the stabilized solid product. The stabilized solid product is then dried in a drying unit at a temperature of about 20 to 90 °C. Non-limiting examples of the stabilizing agent include monohydric alcohols such as methanol, ethanol, and 2-propanol.

Vaterite is the least thermodynamically stable of the three anhydrous CaCO₃ polymorphs. Vaterite particles are typically spherule, and can be synthesized using carbon dioxide as a reagent. The reaction may be carried out using calcium hydroxide as a source of Ca²⁺ ions according to the following equation:

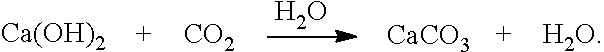

In aqueous solutions and at ambient conditions, calcite, vaterite and aragonite are favorably formed at 30 °C, 40 °C, and 60-80 °C, respectively, before forming calcite at longer reaction times. [10] With the introduction of specific additives during synthesis, primarily species containing magnesium, strontium, sulfates, ammonium, amine and alcohols, greater vaterite stability and polymorphic control may be achieved [5,6,14,16,17,21,22].

Successful synthesis of vaterite from Ca(OH)₂ has been achieved using alcohols as a pre-treatment and as a suspension medium prior to diffusive carbonation at varying relative humidity at near ambient conditions. [7,18,19,23] Although this process was effective, the synthesis required long residence times (hours to days) and demonstrated low yields due to the alcohol and water interaction.

The methods of the present invention advantageously simplify the processing conditions for producing vaterite and avoid the formation of toxic gases. This method also has the potential to produce vaterite using other cement replacement materials (i.e., blast furnace slags, natural pozzolans and fly ash) and utilizing CO₂ borne in flue gas with minimal processing.

Previous studies on Ca(OH)₂ as a flue gas absorbent have found that CO₂ with NOₓ/O₂ and SO₂ (which are chemical species that may be present in dilute concentrations in flue gas) promote CaCO₃ formation at short reaction times (t≤1 hour) and recrystallization into CaSO₃ or CaSO₄ at longer reaction times[21,24]. This may be beneficial, as vaterite precipitates initially, and sulfates are known to inhibit calcite formation from vaterite at short reaction times (t<24 hours)[24 ]. At sufficiently high NOₓ/O₂ concentrations, formation of calcium nitrite or nitrate, which can be used as admixtures in concrete, may also be observed. Similarly, low concentrations of CaSO₄ have been found to accelerate the transformation of vaterite in cement systems. If higher purity of vaterite were desired, appropriate adjustments of the operating conditions and integration of gas scrubbing units may be utilized to minimize the by-product concentration in the cement product. Accordingly, the present disclosure provides a simpler approach that addresses some of the limitations of current vaterite synthesis methods and offers several avenues for future expansion. Stabilized vaterite formed according to the present disclosure may advantageously be used in concrete production, thus reducing the overall eCI of concrete.

Thus, in certain aspects provided herein are method of producing stabilized vaterite, comprising:
(i) combining an alkaline calcium source with an additive to form a reactant mixture;
(ii) carbonating the reactant mixture with a CO₂ source to form a solid CaCO₃ product comprising vaterite; and
(iii) adding a stabilizing agent to the solid CaCO₃ product of step (ii) thereby producing the stabilized vaterite.

In certain embodiments, the alkaline calcium source is selected from calcium hydroxide, recycled concrete, hydrated cementitious solids, slags, fly ashes, anhydrous calcium silicates, alkaline Ca-bearing rocks, and any combination thereof. In certain preferred embodiments, the alkaline calcium source is calcium hydroxide.

In certain embodiments, the additive is selected from Mg(OH)₂, MgO, CaSO₄, NaOH, and any combination thereof. In more particular embodiments, the additive is selected from Mg(OH)₂, MgO, and a combination thereof.

In certain embodiments, the reactant mixture formed in step (i) is an aqueous solution. In certain embodiments, the reactant mixture has a molar ratio of calcium to magnesium of about 0.1 to about 0.25. In some embodiments, the reactant mixture has a molar ratio of calcium to magnesium of about 0.1. In some embodiments, the reactant mixture has a molar ratio of calcium to magnesium of about 0.15. In some embodiments, the reactant mixture has a molar ratio of calcium to magnesium of about 0.2. In some embodiments, the reactant mixture has a molar ratio of calcium to magnesium of about 0.25. The present methods advantageously provide a method of producing a stabilized vaterite under relatively mild temperature and pressure conditions. In certain embodiments, the combining of the alkaline calcium source with the additive is at a temperature of about 20 °C to about 30 °C. In some embodiments, the combining of the alkaline calcium source with the additive is at a temperature of about 20 °C. In some embodiments, the combining of the alkaline calcium source with the additive is at a temperature of about 21 °C. In some embodiments, the combining of the alkaline calcium source with the additive is at a temperature of about 22 °C. In some embodiments, the combining of the alkaline calcium source with the additive is at a temperature of about 23 °C. In some embodiments, the combining of the alkaline calcium source with the additive is at a temperature of about 24 °C. In some embodiments, the combining of the alkaline calcium source with the additive is at a temperature of about 25 °C. In some embodiments, the combining of the alkaline calcium source with the additive is at a temperature of about 26 °C. In some embodiments, the combining of the alkaline calcium source with the additive is at a temperature of about 27 °C. In some embodiments, the combining of the alkaline calcium source with the additive is at a temperature of about 28 °C. In some embodiments, the combining of the alkaline calcium source with the additive is at a temperature of about 29 °C. In some embodiments, the combining of the alkaline calcium source with the additive is at a temperature of about 30 °C. In certain embodiments, the combining of the alkaline calcium source with the additive is carried out at a pressure of about 0.8 to about 1.2 MPa, more preferably about 0.9 to about 1.1 MPa, and most preferably about 0.1 MPa. In some embodiments, the combining the alkaline calcium source with the additive is at atmospheric pressure.

In certain embodiments, the reactant mixture is carbonated at a temperature from about 25 °C to about 65 °C. In some embodiments, the reactant mixture is carbonated at a temperature from about 35 °C to about 55 °C. In some embodiments, the reactant mixture is carbonated at a temperature from about 20 °C to 50 °C. In some embodiments, the reactant mixture is carbonated at a temperature of about 20 °C. In some embodiments, the reactant mixture is carbonated at a temperature of about 25 °C. In some embodiments, the reactant mixture is carbonated at a temperature of about 30 °C. In some embodiments, the reactant mixture is carbonated at a temperature of about 35 °C. In some embodiments, the reactant mixture is carbonated at a temperature of about 40 °C. In some embodiments, the reactant mixture is carbonated at a temperature of about 45 °C. In some embodiments, the reactant mixture is carbonated at a temperature of about 50 °C. In some embodiments, the reactant mixture is carbonated at a temperature of about 55 °C. In some embodiments, the reactant mixture is carbonated at a temperature of about 60 °C. In some embodiments, the reactant mixture is carbonated at a temperature of about 65 °C.

In certain embodiments, the reactant mixture is carbonated at a relative humidity from about 30% to about 75%. In some embodiments, the reactant mixture is carbonated at a relative humidity from about 40% to about 65%. In some embodiments, the reactant mixture is carbonated at a relative humidity of about 30% to about 50%. In some embodiments, the reactant mixture is carbonated at a relative humidity of about 30%. In some embodiments, the reactant mixture is carbonated at a relative humidity of about 35%. In some embodiments, the reactant mixture is carbonated at a relative humidity of about 40%. In some embodiments, the reactant mixture is carbonated at a relative humidity of about 45%. In some embodiments, the reactant mixture is carbonated at a relative humidity of about 50%. In some embodiments, the reactant mixture is carbonated at a relative humidity of about 55%. In some embodiments, the reactant mixture is carbonated at a relative humidity of about 60%. In some embodiments, the reactant mixture is carbonated at a relative humidity of about 65%. In some embodiments, the reactant mixture is carbonated at a relative humidity of about 70%. In some embodiments, the reactant mixture is carbonated at a relative humidity of about 75%.

In certain embodiments, the concentration of CO 2 during carbonation is from about 4 to about 20 volume %. In some embodiments, the concentration of CO 2 during carbonation is from about 10 to about 15 volume %. In some embodiments, the concentration of CO 2 during carbonation is about 2-100 volume %. In some embodiments, the concentration of CO 2 during carbonation is about 10 volume %. In some embodiments, the concentration of CO 2 during carbonation is about 11 volume %. In some embodiments, the concentration of CO 2 during carbonation is about 12 volume %. In some embodiments, the concentration of CO 2 during carbonation is about 13 volume %. In some embodiments, the concentration of CO 2 during carbonation is about 14 volume %. In some embodiments, the concentration of CO 2 during carbonation is about 15 volume %.

In certain embodiments, carbonation is completed at a pressure of about 0.8 to about 1.2 MPa, more preferably about 0.9 to about 1.1 MPa, and most preferably about 0.1 MPa.

Any source of CO₂ may be used in the present methods. In some preferred embodiments, the CO₂ source may be a treated or untreated flue gas.

In certain embodiments, adding the stabilizing agent to the vaterite occurs at a temperature of about 15 °C to about 65 °C. In some embodiments, adding the stabilizing agent to the vaterite occurs at a temperature of about 15 °C. In some embodiments, adding the stabilizing agent to the vaterite occurs at a temperature of about 20 °C. In some embodiments, adding the stabilizing agent to the vaterite occurs at a temperature of about 25 °C. In some embodiments, adding the stabilizing agent to the vaterite occurs at a temperature of about 30 °C. In some embodiments, adding the stabilizing agent to the vaterite occurs at a temperature of about 35 °C. In some embodiments, adding the stabilizing agent to the vaterite occurs at a temperature of about 40 °C. In some embodiments, adding the stabilizing agent to the vaterite occurs at a temperature of about 45 °C. In some embodiments, adding the stabilizing agent to the vaterite occurs at a temperature of about 50 °C. In some embodiments, adding the stabilizing agent to the vaterite occurs at a temperature of about 55 °C. In some embodiments, adding the stabilizing agent to the vaterite occurs at a temperature of about 60 °C. In some embodiments, adding the stabilizing agent to the vaterite occurs at a temperature of about 65 °C.

In certain embodiments, adding the stabilizing agent to the vaterite occurs at a pressure of about 0.8 to about 1.2 MPa, more preferably about 0.9 to about 1.1 MPa, and most preferably about 0.1 MPa.

In certain embodiments, the stabilizing agent inhibits aragonite and/or calcite formation. In some embodiments, the stabilizing agent comprises a monohydric alcohol. In some embodiments, the stabilizing agent is selected from methanol, ethanol and 2-propanol. In other embodiments, the stabilizing agent is ethanol, polyethylene glycol, or both ethanol and polyethylene glycol.

In certain embodiments, the concentration of the stabilizing agent is from about 1-90 mass % of the stabilized vaterite, more preferably from about 1-10 mass % of the stabilized solid product, and most preferably from about 1-5 mass % of the stabilized solid product In certain embodiments, the stabilized vaterite is dried in a drying unit at temperatures of about 20-90 °C, and more preferably the stabilized solid product is dried in a drying unit at temperatures of about 20-60 °C.

In certain embodiments, the method further comprises mechanically treating the solid reactant mixture by sonicating, grinding, milling, or mixing.

In some embodiments, the solid CaCO₃ product of step (ii) comprises at least 40 mass % of vaterite. In some embodiments, the product comprises at least 50%, 60% or 70% mass % of vaterite.

In certain embodiments, the solid CaCO₃ product of step (ii) comprises about 0 to about 60% Ca(OH)₂, about 0 to about 0 -60 mass % aragonite, and about 0 to about 60 mass % of calcite.

The present invention further provides a stabilized vaterite prepared by the above-described methods.

### REFERENCES

[1] Moorehead, D. R. Cementation by the Carbonation of Hydrated Lime. Cem. Concr. Res. 1986, 16(5), 700-708. https://doi.org/10.1016/0008-8846(86)90044-X.
[2] Tone, T.; Koga, N. Thermally Induced Aragonite-Calcite Transformation in Freshwater Pearl: A Mutual Relation with the Thermal Dehydration of Included Water. ACS Omega 2021, 6 (21), 13904-13914. https://doi.org/10.1021/acsomega.1c01683.
[3] Maruyama, I.; Kotaka, W.; Kien, B. N.; Kurihara, R.; Kanematsu, M.; Hyodo, H.; Hirao, H.; Kitagaki, R.; Tamura, M.; Tsujino, M.; Fujimoto, S.; Noguchi, T. A New Concept of Calcium Carbonate Concrete Using Demolished Concrete and CO₂. J. Adv. Concr. Technol. 2021, 19(10), 1052-1060. https://doi.org/10.3151/jact.19.1052.
[4] U.S. Pat. No. 9,133,581-B2-Non-cementitious Compositions Comprising Vaterite and Methods Thereof |Unified Patents https://portal.unifiedpatents.com/patents/patent/U.S. Pat. No. 9133581-B2.
[5] Jose, S. (75) Inventors: Brent R. Constantz, Portola Valley, CA (US); Kasra Farsad, San Jose, CA (US); Chris Camire, San Jose, CA (US); Irvin. 105.
[6] Hargis, C. W.; Chen, I. A.; Devenney, M.; Fernandez, M. J.; Gilliam, R. J.; Thatcher, R. P. Calcium Carbonate Cement: A Carbon Capture, Utilization, and Storage (CCUS) Technique. Materials 2021, 14 (11), 2709. https://doi.org/10.3390/ma14112709.
[7] Rodriguez-Navarro, C.; Suzuki, A.; Ruiz-Agudo, E. Alcohol Dispersions of Calcium Hydroxide Nanoparticles for Stone Conservation. Langmuir 2013, 29 (36), 11457-11470. https://doi.org/10.1021/la4017728.
[8] Nakano, K.; Mito, S.; Xue, Z. Self-Sealing of Wellbore Cement under the CO₂ Batch Experiment Using Well Composite Sample. Energy Procedia 2017, 114, 5212-5218. https://doi.org/10.1016/j.egypro.2017.03.1677.
[9] Chen, P.; Wang, J.; Wang, L.; Xu, Y.; Qian, X.; Ma, H. Producing Vaterite by CO₂ Sequestration in the Waste Solution of Chemical Treatment of Recycled Concrete Aggregates. J. Clean. Prod. 2017, 149, 735-742. https://doi.org/10.1016/j.jclepro.2017.02.148.
[10] Konopacka-Łyskawa, D. Synthesis Methods and Favorable Conditions for Spherical Vaterite Precipitation: A Review. Crystals 2019, 9 (4), 223. https://doi.org/10.3390/cryst9040223.
[11] Ruiz-Agudo, E.; Putnis, C. V.; Putnis, A. Coupled Dissolution and Precipitation at Mineral-Fluid Interfaces. Chem. Geol. 2014, 383, 132-146. https://doi.org/10.1016/j.chemgeo.2014.06.007.
[12] Pérez-Villarejo, L.; Takabait, F.; Mahtout, L.; Carrasco-Hurtado, B.; Eliche-Quesada, D.; Sánchez-Soto, P. J. Synthesis of Vaterite CaCO₃ as Submicron and Nanosized Particles Using Inorganic Precursors and Sucrose in Aqueous Medium. Ceram. Int. 2018, 44(5), 5291-5296. https://doi.org/10.1016/j.ceramint.2017.12.142.
[13] Siva, T.; Muralidharan, S.; Sathiyanarayanan, S.; Manikandan, E.; Jayachandran, M. Enhanced Polymer Induced Precipitation of Polymorphous in Calcium Carbonate: Calcite Aragonite Vaterite Phases. J. Inorg. Organomet. Polym. Mater. 2017, 27(3), 770-778. https://doi.org/10.1007/s10904-017-0520-1.
[14] Nebel, H.; Epple, M. Continuous Preparation of Calcite, Aragonite and Vaterite, and of Magnesium-Substituted Amorphous Calcium Carbonate (Mg-ACC). Z. Für Anorg. Allg. Chem. 2008, 634(8), 1439-1443. https://doi.org/10.1002/zaac.200800134.
[15] Zhou, G.-T.; Yao, Q.-Z.; Fu, S.-Q.; Guan, Y.-B. Controlled Crystallization of Unstable Vaterite with Distinct Morphologies and Their Polymorphic Transition to Stable Calcite. Eur. J. Mineral. 2010, 22(2), 259-269. https://doi.org/10.1127/0935-1221/2009/0022-2008.
[16] Loste, E.; Wilson, R. M.; Seshadri, R.; Meldrum, F. C. The Role of Magnesium in Stabilising Amorphous Calcium Carbonate and Controlling Calcite Morphologies. J. Cryst. Growth 2003, 254 (1), 206-218. https://doi.org/10.1016/S0022-0248(03)01153-9.
[17] Blue, C. R.; Giuffre, A.; Mergelsberg, S.; Han, N.; De Yoreo, J. J.; Dove, P. M. Chemical and Physical Controls on the Transformation of Amorphous Calcium Carbonate into Crystalline CaCO₃ Polymorphs. Geochim. Cosmochim. Acta 2017, 196, 179-196. https://doi.org/10.1016/j.gca.2016.09.004.
[18] Gomez-Villalba, L. S.; López-Arce, P.; Fort, R. Nucleation of CaCO₃ Polymorphs from a Colloidal Alcoholic Solution of Ca(OH)₂ Nanocrystals Exposed to Low Humidity Conditions. Appl. Phys. A 2012, 106 (1), 213-217. https://doi.org/10.1007/s00339-011-6550-6.
[19] Gomez-Villalba, L. S.; López-Arce, P.; Alvarez de Buergo, M.; Fort, R. Structural Stability of a Colloidal Solution of Ca(OH)₂ Nanocrystals Exposed to High Relative Humidity Conditions. Appl. Phys. A 2011, 104 (4), 1249-1254. https://doi.org/10.1007/s00339-011-6457-2.
[20] López-Arce, P.; Gómez-Villalba, L. S.; Martínez-Ramírez, S.; Alvarez de Buergo, M.; Fort, R. Influence of Relative Humidity on the Carbonation of Calcium Hydroxide Nanoparticles and the Formation of Calcium Carbonate Polymorphs. Powder Technol. 2011, 205 (1), 263-269. https://doi.org/10.1016/j.powtec.2010.09.026.
[21] Fernández-Díaz, L.; Fernández-González, A.; Prieto, M. The Role of Sulfate Groups in Controlling CaCO₃ Polymorphism. Geochim. Cosmochim. Acta 2010, 74 (21), 6064-6076.https://doi.org/10.1016/j.gca.2010.08.010.
[22] Konopacka-Łyskawa, D.; Kościelska, B.; Karczewski, J.; Goła̧biewska, A. The Influence of Ammonia and Selected Amines on the Characteristics of Calcium Carbonate Precipitated from Calcium Chloride Solutions via Carbonation. Mater. Chem. Phys. 2017, 193, 13-18. https://doi.org/10.1016/j.matchemphys.2017.01.060.
[23] Tomasin, P.; Mondin, G.; Zuena, M.; El Habra, N.; Nodari, L.; Moretto, L. M. Calcium Alkoxides for Stone Consolidation: Investigating the Carbonation Process. Powder Technol. 2019, 344, 260-269. https://doi.org/10.1016/j.powtec.2018.12.050.
[24] Liu, C.-F.; Shih, S.-M. Effects of Flue Gas Components on the Reaction of Ca(OH)₂ with SO 2. Ind. Eng. Chem. Res. 2006, 45(26), 8765-8769. https://doi.org/10.1021/ie 0605534.

### INCORPORATION BY REFERENCE

All publications and patents mentioned herein are hereby incorporated by reference in their entirety as if each individual publication or patent was specifically and individually indicated to be incorporated by reference. In case of conflict, the present application, including any definitions herein, will control.

### EQUIVALENTS

While specific embodiments of the subject invention have been discussed, the above specification is illustrative and not restrictive. Many variations of the invention will become apparent to those skilled in the art upon review of this specification and the claims below. The full scope of the invention should be determined by reference to the claims, along with their full scope of equivalents, and the specification, along with such variations.

We claim:

1. A method of producing stabilized vaterite, comprising:
(i) combining an alkaline calcium source with an additive to form a reactant mixture;
(ii) carbonating the reactant mixture with a CO₂ source to form a solid CaCO₃ product comprising vaterite; and
(iii) adding a stabilizing agent to the solid CaCO₃ product of step (ii) thereby producing the stabilized vaterite.

2. The method of claim 1, wherein the alkaline calcium source is selected from Ca(OH)₂, recycled concrete, hydrated cementitious solids, slags, fly ashes, anhydrous calcium silicates, alkaline Ca-bearing rocks, and any combination thereof.

3. The method of claim 1 or 2, wherein the alkaline calcium source is Ca(OH)_{2.}

4. The method of any one of claims 1-3, wherein the additive is selected from Mg(OH)₂, MgO, CaSO₄, NaOH, and combinations thereof.

5. The method of any one of claims 1-4, wherein the additive is Mg(OH)₂, MgO, or a combination thereof.

6. The method of any one of claims 1-5, wherein the reactant mixture formed in step (i) is an aqueous solution.

7. The method of any one of claims 1-6, wherein the reactant mixture has a molar ratio of calcium to magnesium of about 0.1 to about 0.25.

8. The method of any one of claims 1-7, wherein the combining of the or alkaline calcium source with the additive is at a temperature of about 20 °C to about 30 °C.

9. The method of any one of claims 1-8, wherein the combining the alkaline calcium source with the additive is at a pressure of about 0.1 MPa.

10. The method of any one of claims 1-8, wherein the combining the alkaline calcium source with the additive is at atmospheric pressure.

11. The method of any one of claims 1-10, wherein the reactant mixture is carbonated at a temperature from about 25 °C to about 65 °C.

12. The method of any one of claims 1-13, wherein the reactant mixture is carbonated at a temperature from about 35 °C to about 55 °C.

13. The method of any one of claims 1-14, wherein the reactant mixture is carbonated at a temperature from about 20 °C to 50°C.

14. The method of any one of claims 1-13, wherein the reactant mixture is carbonated at a relative humidity from about 30% to about 75%.

15. The method of any one of claims 1-13, wherein the reactant mixture is carbonated at a relative humidity from about 40% to about 65%.

16. The method of any one of claims 1-13, wherein the reactant mixture is carbonated at a relative humidity of about 30% to about 50%.

17. The method of any one of claims 1-16, wherein the concentration of CO₂ during carbonation is about 2-100 volume %.

18. The method of any one of claims 1-17, wherein the concentration of CO₂ during carbonation is from about 4 to about 20 volume %.

19. The method of any one of claims 1-18, wherein the concentration of CO₂ during carbonation is from about 10 to about 15 volume %.

20. The method of any one of claims 1-19, wherein carbonation is completed at a pressure of about 0.1 MPa.

21. The method of any one of claims 1-20, wherein the CO₂ source comprises a treated or untreated flue gas.

22. The method of any one of claims 1-21, wherein adding the stabilizing agent to the vaterite occurs at a temperature of about 15 °C to about 65 °C.

23. The method of any one of claims 1-22, wherein adding the stabilizing agent to the vaterite occurs at a pressure of about 0.1 MPa.

24. The method of any one of claims 1-23, wherein the stabilizing agent inhibits aragonite and/or calcite formation.

25. The method of any one of claims 1-24, wherein the stabilizing agent comprises a monohy dric alcohol.

26. The method of any one of claims 1-25, wherein the stabilizing agent is selected from methanol, ethanol, and 2-propanol.

27. The method of any one of claims 1-24, wherein the stabilizing agent is ethanol, polyethylene glycol, or both ethanol and polyethylene glycol.

28. The method of any one of claims 1 to 27, wherein the concentration of the stabilizing agent is from about 1-90 mass % of the solid CaCO₃ product.

29. The method of any one of claims 1 to 28, wherein the concentration of the stabilizing agent is from about 1-10 mass % of the solid CaCO₃ product.

30. The method of any one of claims 1 to 29, wherein the concentration of the stabilizing agent is from about 1-5 mass % of the solid CaCO₃ product.

31. The method of any one of claims 1 to 30, wherein the stabilized vaterite is dried in drying unit at temperatures of about 20-90°C.

32. The method of any one of the claims of 1 to 31, wherein the stabilized vaterite-is dried in a drying unit at temperatures of about 20-60°C.

33. The method of any one of claims 1 to 32, further comprising mechanically treating the reactant mixture by sonicating, grinding, milling, or mixing.

34. The method of any one of claims 1 to 33, wherein the solid CaCO₃ product of step (ii) comprises at least 40 mass % of stabilized vaterite.

35. The method of any one of claims 1 to 34, wherein the solid CaCO₃ product of step (ii) comprises from 0 to about 60 mass % Ca(OH)₂, from 0 to about 60 mass % aragonite, and from 0 to about 60 mass % calcite.

36. A stabilized vaterite prepared by the method of any one of claims 1 to 35.
